(19) United States
(12) Patent Application Publication
(10) Pub. No.: US 2026/0121226 A1
(43) Pub. Date: Apr. 30, 2026

(54) LAMINATED SEPARATOR FOR NONAQUEOUS ELECTROLYTE SECONDARY BATTERY AND USE THEREOF

(71) Applicant: SUMITOMO CHEMICAL COMPANY, LIMITED, Tokyo (JP)

(72) Inventors: Masumi YAMASHITA, Niihama-shi (JP); Taiga ISHII, Niihama-shi (JP); Riku MATSUMINE, Niihama-shi (JP)

(21) Appl. No.: 19/371,389

(22) Filed: Oct. 28, 2025

(30) Foreign Application Priority Data
Oct. 31, 2024 (JP) 2024-192240

(51) Int. Cl. H01M 50/449; H01M 50/417; H01M 50/42; H01M 50/423; H01M 50/426; H01M 50/443

(52) U.S. Cl. CPC H01M 50/449; H01M 50/417; H01M 50/42; H01M 50/443; H01M 50/423; H01M 50/426

(57) ABSTRACT

Provided is a laminated separator for a nonaqueous electrolyte secondary battery superior in stability of high-rate performance under applied pressure. The laminated separator of the present disclosure includes a polyolefin porous film, and a porous layer provided on one surface or both surfaces of the polyolefin porous film. The laminated separator further include a particle layer on at least one surface. The laminated separator satisfies the relationship where the coefficient of variation of the compression amount during compression at 5 MPa÷the coefficient of variation of the compression amount during compression at 1 MPa≤0.9.

This Nonprovisional application claims priority under 35 U.S.C. § 119 on Patent Application No. 2024-192240 filed in Japan on Oct. 31, 2024, the entire contents of which are hereby incorporated by reference.

### TECHNICAL FIELD

The present invention relates to a laminated separator for a nonaqueous electrolyte secondary battery (hereinafter referred to as a “nonaqueous electrolyte secondary battery laminated separator”), a material for a nonaqueous electrolyte secondary battery (hereinafter referred to as a “nonaqueous electrolyte secondary battery material”), and a nonaqueous electrolyte secondary battery.

### BACKGROUND ART

Nonaqueous electrolyte secondary batteries, particularly lithium ion secondary batteries, have a high energy density, and are therefore widely used as batteries for personal computers, mobile telephones, portable information terminals, cars, and the like.

A lithium ion secondary battery generally includes a separator provided between a positive electrode and a negative electrode. For example, Patent Literature 1 discloses a nonaqueous secondary battery separator that includes a heat-resistant porous layer containing an aromatic resin and inorganic particles, and an adhesive layer containing adhesive resin particles containing a phenyl group-containing acrylic resin.

### CITATION LIST

### Patent Literature

### [Patent Literature 1]

Japanese Patent Application Publication Tokukai No. 2023-40937

### SUMMARY OF INVENTION

### Technical Problem

A separator incorporated into a nonaqueous electrolyte secondary battery might be compressed due to the expansion of adjacent electrodes. This might apply pressure to a porous layer provided in the separator. Such a conventional technique as described above has room for improvement from the viewpoint of the stability of high-rate performance under applied pressure. An object of an aspect of the present invention is to provide a nonaqueous electrolyte secondary battery laminated separator that is superior in stability of high-rate performance under applied pressure.

### Solution to Problem

To achieve the object, a laminated separator for a nonaqueous electrolyte secondary battery in accordance with an aspect of the present invention is a laminated separator that is for a nonaqueous electrolyte secondary battery, including a polyolefin porous film, and a porous layer provided on one surface or both surfaces of the polyolefin porous film,
the laminated separator further including a particle layer on at least one surface,
the laminated separator satisfying the following formula:

$$( coefficient of variation of compression amount during compression at 5 MPa ) \div ( coefficient of variation of compression amount during compression at 1 MPa ) \leq 0.9 .$$

### Advantageous Effects of Invention

In accordance with an aspect of the present invention, it is possible to provide a nonaqueous electrolyte secondary battery laminated separator that is superior in stability of high-rate performance under applied pressure.

### BRIEF DESCRIPTION OF DRAWINGS

FIG. 1 is a schematic diagram schematically illustrating a structure of a nonaqueous electrolyte secondary battery laminated separator in accordance with an embodiment of the present invention.

FIG. 2 is a schematic diagram schematically illustrating a structure of a nonaqueous electrolyte secondary battery laminated separator in accordance with an embodiment of the present invention.

FIG. 3 is a schematic diagram schematically illustrating a structure of a nonaqueous electrolyte secondary battery laminated separator in accordance with an embodiment of the present invention.

FIG. 4 is a schematic diagram schematically illustrating a structure of a nonaqueous electrolyte secondary battery laminated separator in accordance with an embodiment of the present invention.

### DESCRIPTION OF EMBODIMENTS

The following description will discuss an embodiment of the present invention. The present invention is, however, not limited to the embodiment below. Note that a numerical range “A to B” herein means “not less (lower) than A and not more (higher) than B” unless otherwise stated.

As used herein, the nonaqueous electrolyte secondary battery laminated separator is also simply referred to as “laminated separator”. As used herein, the polyolefin porous film is also simply referred to as “porous film”.

### [1. Nonaqueous Electrolyte Secondary Battery Laminated Separator]

The nonaqueous electrolyte secondary battery laminated separator in accordance with an embodiment of the present invention includes the polyolefin porous film, a porous layer, and a particle layer. The porous layer is provided on one surface or both surfaces of the porous film. The particle layer is provided on at least one surface of the laminated separator.

The laminated separator satisfies the relationship where the coefficient of variation of the compression amount during compression at 5 MPa÷the coefficient of variation of the compression amount during compression at 1 MPa≤0.9. This value may be not more than 0.85, not more than 0.8, not more than 0.75, not more than 0.74, not more than 0.73, not more than 0.72, or not more than 0.71. The lower limit of this value may be not less than 0.00 or not less than 0.01.

The compression amount during compression is determined from a curve obtained by plotting the position of an indenter on the horizontal axis and the indentation pressure on the vertical axis. The difference between the position of the indenter at a time point where the indentation pressure is 1 MPa and the position of the indenter at the start of contact between the indenter and the sample is the compression amount during compression at 1 MPa. The difference between the position of the indenter at a time point where the indentation pressure is 5 MPa and the position of the indenter at the start of contact between the indenter and the sample is the compression amount during compression at 5 MPa. The difference between the position of the indenter at a time point where the indentation pressure is 10 MPa and the position of the indenter at the start of contact between the indenter and the sample is the compression amount during compression at 10 MPa.

The coefficient of variation of the compression amount is determined by measuring the compression amount during compression at 15 different locations on a single laminated separator. A value calculated by dividing the standard deviation of the data obtained from the 15 points by the average of the data from the 15 points serves as the coefficient of variation of the compression amount during compression.

Compression at 1 MPa substantially corresponds to the pressure applied when the laminated separator and electrode plates are pressed to prepare a nonaqueous electrolyte secondary battery material. Thus, the coefficient of variation of the compression amount during compression at 1 MPa is considered to be influenced by the properties of the particle layer and the porous layer. Specifically, it is considered that the coefficient of variation is influenced by the extent to which the particle layer is uniformly compressed and the degree of unevenness on the surface of the porous layer when pressing is carried out to prepare the nonaqueous electrolyte secondary battery material.

Compression at 5 MPa or 10 MPa substantially corresponds to the internal pressure experienced when the assembled battery was charged and discharged. Thus, the coefficient of variation of the compression amount during compression at 5 MPa or 10 MPa is considered to be influenced by the properties of the porous layer. Specifically, it is considered that the coefficient of variation is influenced by the extent to which the porous layer is uniformly compressed when localized pressure is applied to the porous layer due to charging and discharging.

The laminated separator satisfies the relationship where the coefficient of variation of the compression amount during compression at 5 MPa÷the coefficient of variation of the compression amount during compression at 1 MPa≤0.9. It is required that the coefficient of variation of the compression amount during compression at 1 MPa be large, and the coefficient of variation of the compression amount during compression at 5 MPa be small. If the coefficient of variation of the compression amount during compression at 1 MPa is large, the particle layer compresses unevenly or the unevenness on the surface of the porous layer is significant, resulting in the formation of microscopic gaps between the laminated separator and the electrode plates in the nonaqueous electrolyte secondary battery material. Such a nonaqueous electrolyte secondary battery material can be said to improve the electrolyte retention and to contribute to the stabilization of rate performance. If the coefficient of variation of the compression amount during compression at 5 MPa is small, the porous layer is compressed uniformly due to charging and discharging, so that the porous layer is less likely to become locally thinner. Such a nonaqueous electrolyte secondary battery can be said to contribute to the stabilization of rate performance. In this way, it is considered that in an embodiment of the present invention, the stabilization of rate performance (particularly high-rate performance) can be achieved through the effective interplay of the coefficients of variation of the two types of compression amounts.

In the laminated separator, the lower limit of the coefficient of variation of the compression amount during compression at 1 MPa may be not less than 0.20, not less than 0.22, not less than 0.24, not less than 0.25, not less than 0.26, not less than 0.28, or not less than 0.30. The upper limit of the coefficient of variation of the compression amount during compression at 1 MPa may be not more than 0.50, not more than 0.45, or not more than 0.40.

In the laminated separator, the upper limit of the coefficient of variation of the compression amount during compression at 5 MPa may be not more than 0.30, not more than 0.28, not more than 0.26, not more than 0.24, not more than 0.22, or not more than 0.20. The lower limit of the coefficient of variation of the compression amount during compression at 5 MPa may be not less than 0.05 or not less than 0.10.

In the laminated separator, the upper limit of the coefficient of variation of the compression amount during compression at 10 MPa may be not more than 0.30, not more than 0.28, not more than 0.26, not more than 0.24, not more than 0.22, not more than 0.20, not more than 0.18, not more than 0.16, or not more than 0.14. The lower limit of the coefficient of variation of the compression amount during compression at 10 MPa may be not less than 0.05 or not less than 0.10.

In the laminated separator, the upper limit of the value obtained by dividing the coefficient of variation of the compression amount during compression at 10 MPa by the coefficient of variation of the compression amount during compression at 1 MPa may be not more than 0.8, not more than 0.75, not more than 0.7, not more than 0.65, not more than 0.6, not more than 0.55, not more than 0.54, not more than 0.53, not more than 0.52, not more than 0.51, or not more than 0.50. The lower limit of this value may be not less than 0.00 or not less than 0.01.

### <1.1. Configurations of Laminated Separator>

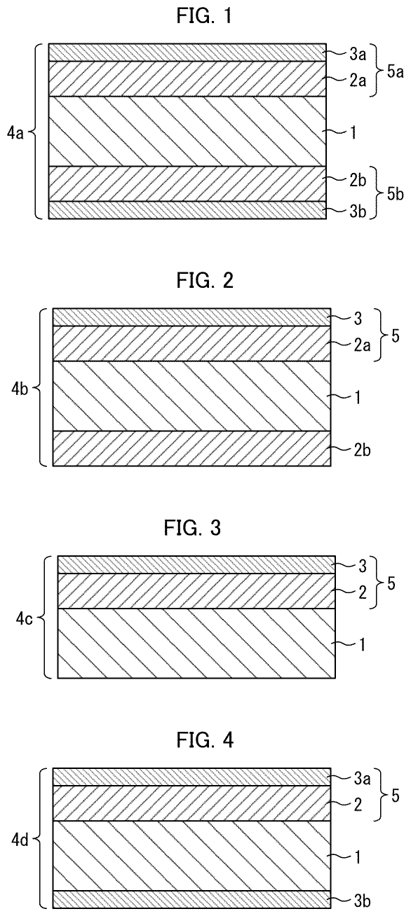

In the laminated separator, the particle layer may be provided on the surface of the laminated separator, or another layer may be further provided on the particle layer. The following description will specifically discuss configurations of the laminated separator with reference to FIGS. 1 to 4.

As illustrated in FIG. 1, in an embodiment, a laminated separator 4a includes a porous film 1, porous layers 2a and 2b which are provided on both surfaces of the porous film 1, and particle layers 3a and 3b which are provided on surfaces on both sides of the laminated separator 4a. The porous layer 2a and the particle layer 3a constitute a laminate 5a. The porous layer 2b and the particle layer 3b constitute a laminate 5b.

As illustrated in FIG. 2, in an embodiment, a laminated separator 4b includes a porous film 1, porous layers 2a and 2b which are provided on both surfaces of the porous film 1, and a particle layer 3 which is provided on a surface on one side of the laminated separator 4b. The porous layer 2a and the particle layer 3 constitute a laminate 5.

Further, as illustrated in FIG. 3, in an embodiment, a laminated separator 4c includes a porous film 1, a porous layer 2 which is provided on one surface of the porous film 1, and a particle layer 3 which is provided on a surface of the laminated separator 4c on the side where the porous layer 2 is provided. The porous layer 2 and the particle layer 3 constitute a laminate 5.

Besides the above configurations, as illustrated in FIG. 4, in an embodiment, a laminated separator 4d includes a porous film 1, a porous layer 2 which is provided on one surface of the porous film 1, and particle layers 3a and 3b which are provided on surfaces on both sides of the laminated separator 4d. The porous layer 2 and the particle layer 3a constitute a laminate 5.

### <1.2. Polyolefin Porous Film>

The laminated separator includes a polyolefin porous film. As used herein, the term “polyolefin porous film” refers to a base material that contains a polyolefin-based resin as a main component. The phrase “contains a polyolefin-based resin as a main component” means that the polyolefin-based resin is contained, in the porous film, at a proportion of not less than 50% by weight, preferably not less than 90% by weight, and more preferably not less than 95% by weight with respect to all materials that constitute the porous film.

The porous film contains a polyolefin-based resin as a main component and has therein many pores connected to one another, so that gas and liquid can pass through the porous film from one surface to the other.

The polyolefin-based resin preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000 because the strength of the laminated separator improves thereby.

Examples of the polyolefin-based resin include homopolymers and copolymers which are each obtained by polymerizing a monomer(s) such as ethylene, propylene, 1-butene, 4-methyl-1-pentene, and/or 1-hexene. Examples of such homopolymers include polyethylene, polypropylene, and polybutene. Examples of the copolymers include an ethylene-propylene copolymer.

Among the above polyolefin-based resins, polyethylene is preferable as the polyolefin-based resin because it is possible to prevent a flow of an excessively large electric current at a lower temperature. Note that the phrase “to prevent a flow of an excessively large electric current” is also referred to as “shutdown”. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these polyethylenes, ultra-high molecular weight polyethylene having a weight-average molecular weight of not less than 1,000,000 is more preferable.

The weight per unit area of the porous film can be determined as appropriate in view of strength, thickness, weight, and handleability. Note, however, that the weight per unit area of the porous film is preferably 2 g/m² to 20 g/m², more preferably 2 g/m² to 12 g/m², and still more preferably 3 g/m² to 10 g/m², so as to allow a nonaqueous electrolyte secondary battery to have a higher weight energy density and a higher volume energy density.

The porous film has an air permeability of preferably 30 s/100 mL to 500 s/100 mL, and more preferably 50 s/100 mL to 300 s/100 mL, in terms of Gurley values. When the air permeability of the porous film falls within these ranges, it can be said that the porous film has sufficient ion permeability.

The porous film has a porosity of preferably 20% by volume to 80% by volume, and more preferably 30% by volume to 75% by volume, so as to (i) retain an electrolyte in a larger amount and (ii) obtain the function of reliably preventing a flow of an excessively large electric current at a lower temperature. Further, in order to achieve sufficient ion permeability and prevent particles from entering the positive electrode and/or the negative electrode, the porous film has pores each having a pore diameter of preferably not more than 0.3 μm, and more preferably not more than 0.14 μm.

The lower limit of the thickness of the porous film is preferably not less than 3 μm, more preferably not less than 4 μm, and still more preferably not less than 5 μm. The upper limit of the thickness of the porous film is preferably not more than 29 μm, more preferably not more than 20 μm, and still more preferably not more than 15 μm. Examples of a combination of a lower limit and an upper limit of the thickness of the porous film include 3 μm to 29 μm, 4 μm to 20 μm, and 5 μm to 15 μm.

### <1.3. Porous Layer>

The porous layer may contain a resin. It is preferable that the resin be insoluble in the electrolyte of the battery and, when the battery is in normal use, be electrochemically stable.

The porous layer may be a heat-resistant layer. The heat-resistant layer contains a heat-resistant resin. The heat-resistant layer means a layer having a melting temperature higher than that of the base material. The heat-resistant resin can be a resin which has a melting point or a glass transition temperature higher than that of the resin constituting the polyolefin porous film.

Examples of the resin contained in the porous layer include: polyolefins; acrylic resins; nitrogen-containing resins; aromatic resins; fluorine-containing resins; polyester-based resins; rubbers; resins each having a melting point or a glass transition temperature of not lower than 180° C.; water-soluble polymers; polycarbonate; polyacetals; and polyether ether ketones.

Preferable examples of the polyolefins include polyethylene, polypropylene, polybutene, and an ethylene-propylene copolymer.

Examples of the acrylic resins include an acrylic resin that contains, as a constituent unit, a (meth)acrylic ester monomer. Details will be described later. As used herein, the “(meth)acrylic” means “acrylic” and/or “methacrylic”.

The nitrogen-containing resins mean resins that contain nitrogen atoms. Examples of the nitrogen-containing resins include polyamides, polyimides, polyamide imides, polybenzimidazoles, polyurethanes, and melamine resins.

The aromatic resins mean resins each containing a structural unit having at least an aromatic group. Examples of the aromatic resins include nitrogen-containing aromatic resins. Examples of the nitrogen-containing aromatic resins include aromatic polyamides such as a wholly aromatic polyamide (aramid resin) and a semi-aromatic polyamide, aromatic polyimides, aromatic polyamide imides, polybenzimidazoles, aromatic polyurethanes, and melamine resins.

Examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, a metaphenylene terephthalamide/2,6-dichloroparaphenylene terephthalamide copolymer, a paraphenylene terephthalamide/3,4′-oxydiphenylene terephthalamide copolymer, poly(4,4′-diphenylsulfonyl terephthalamide), and a paraphenylene terephthalamide/4,4′-diphenylsulfonyl terephthalamide copolymer. Among these, poly(paraphenylene terephthalamide) is more preferable.

Examples of the fluorine-containing resins include polyvinylidene fluoride (PVdF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. The fluorine-containing resins are particularly exemplified by fluorine-containing rubbers each having a glass transition temperature of not higher than 23° C.

The polyester-based resins are preferably aromatic polyesters such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

In an embodiment, the porous layer contains at least one resin selected from the group consisting of acrylic resin, aromatic polyamide, polyimide, polyamide imide, and polyvinylidene fluoride. Containing these resins improves the heat resistance of the porous layer.

The lower limit of the proportion of a (meth)acrylic ester monomer unit contained in the acrylic resin is preferably not less than 50% by weight, more preferably not less than 55% by weight, still more preferably not less than 60% by weight, and particularly preferably not less than 70% by weight. The upper limit of the proportion of the (meth)acrylic ester monomer unit contained in the acrylic resin is preferably not more than 100% by weight, more preferably not more than 99% by weight, and still more preferably not more than 95% by weight.

Examples of the (meth)acrylic ester monomers that can form the (meth)acrylic ester monomer unit include: acrylic acid alkyl esters such as methyl acrylate, ethyl acrylate, n-propyl acrylate, isopropyl acrylate, butyl acrylate (e.g., n-butyl acrylate and t-butyl acrylate), pentyl acrylate, hexyl acrylate, heptyl acrylate, octyl acrylate (e.g., 2-ethylhexyl acrylate), nonyl acrylate, decyl acrylate, lauryl acrylate, n-tetradecyl acrylate, and stearyl acrylate; and methacrylic acid alkyl esters such as methyl methacrylate, ethyl methacrylate, n-propyl methacrylate, isopropyl methacrylate, butyl methacrylate (e.g., n-butyl methacrylate and t-butyl methacrylate), pentyl methacrylate, hexyl methacrylate, heptyl methacrylate, octyl methacrylate (e.g., 2-ethylhexyl methacrylate), nonyl methacrylate, decyl methacrylate, lauryl methacrylate, n-tetradecyl methacrylate, and stearyl methacrylate. Among these monomers, butyl acrylate and methyl methacrylate are preferable, and butyl acrylate is more preferable. One of the (meth)acrylic ester monomers may be used alone, or two or more of the (meth)acrylic ester monomers may be used in combination at any ratio.

The acrylic resin may have a unit other than the (meth)acrylic ester monomer unit. For example, the acrylic resin may contain an acid group-containing monomer unit. Examples of the acid group-containing monomer include monomers each having an acid group, for example, a monomer having a carboxylic acid group, a monomer having a sulfonic acid group, a monomer having a phosphoric acid group, and a monomer having a hydroxyl group.

Examples of the monomer having a carboxylic acid group include a monocarboxylic acid and a dicarboxylic acid. Examples of the monocarboxylic acid include acrylic acid, methacrylic acid, and crotonic acid. Examples of the dicarboxylic acid include maleic acid, fumaric acid, and itaconic acid.

Examples of the monomer having a sulfonic acid group include vinyl sulfonic acid, methylvinyl sulfonic acid, (meth)allyl sulfonic acid, (meth)acrylic acid 2-ethyl sulfonate, 2-acrylamido-2-methylpropane sulfonic acid, and 3-allyloxy-2-hydroxypropane sulfonic acid.

Examples of the monomer having a phosphoric acid group include 2-(meth)acryloyloxyethyl phosphate, methyl-2-(meth)acryloyloxyethyl phosphate, and ethyl-(meth)acryloyloxyethyl phosphate.

Examples of the monomer having a hydroxyl group include 2-hydroxyethyl acrylate, 2-hydroxypropyl acrylate, 2-hydroxyethyl methacrylate, and 2-hydroxypropyl methacrylate.

Among these monomers, the acid group-containing monomer is preferably a monomer having a carboxylic acid group. Among monomers each having a carboxylic acid group, the monomer having a carboxylic acid group is preferably a monocarboxylic acid and more preferably a (meth)acrylic acid. One of these acid group-containing monomers may be used alone, or two or more of these acid group-containing monomers may be used in combination at any ratio.

The lower limit of the proportion of the acid group-containing monomer unit in the acrylic resin is preferably not less than 0.1% by weight, more preferably not less than 1% by weight, and still more preferably not less than 3% by weight. The upper limit of the proportion of the acid group-containing monomer unit in the acrylic resin is preferably not more than 20% by weight, more preferably not more than 10% by weight, and still more preferably not more than 7% by weight.

The acrylic resin preferably contains a cross-linkable monomer unit in addition to the above monomer unit. A cross-linkable monomer is a monomer which, upon heating or irradiation with an energy beam, can form a cross-linked structure during or after polymerization. Inclusion of the cross-linkable monomer unit in the acrylic resin makes it possible to easily keep a degree of swelling of the polymer in a specific range.

Examples of the cross-linkable monomer include a multifunctional monomer which has two or more polymerization reactive groups in the monomer. Examples of such a multifunctional monomer include: divinyl compounds such as divinylbenzene; di(meth)acrylic ester compounds such as diethylene glycol dimethacrylate, ethylene glycol dimethacrylate, diethylene glycol diacrylate, and 1,3-butylene glycol diacrylate; tri(meth)acrylic ester compounds such as trimethylolpropane trimethacrylate and trimethylolpropane triacrylate; and ethylenically unsaturated monomers each containing an epoxy group such as allyl glycidyl ether and glycidyl methacrylate. Among these monomers, the dimethacrylic ester compounds and the ethylenically unsaturated monomers each containing an epoxy group are preferable, and the dimethacrylic ester compounds are more preferable. One of these monomers may be used alone, or two or more of these monomers may be used in combination at any ratio.

The lower limit of the proportion of the cross-linkable monomer unit in the acrylic resin is preferably not less than 0.1% by weight, more preferably not less than 0.2% by weight, and still more preferably not less than 0.5% by weight. The upper limit of the proportion of the cross-linkable monomer unit in the acrylic resin is preferably not more than 5% by weight, more preferably not more than 4% by weight, and still more preferably not more than 3% by weight.

Note that, as the resin, only one of the above resins may be used, or two or more of the above resins may be used in combination. The resin is contained in the porous layer at a proportion of preferably 25% by weight to 80% by weight and more preferably 30% by weight to 70% by weight when the total weight of the porous layer is 100% by weight.

### (Filler)

The porous layer may further contain a filler. The filler can be an inorganic filler or an organic filler. The filler is preferably an inorganic filler which is made of one or more inorganic oxides selected from the group consisting of silica, calcium oxide, magnesium oxide, magnesium hydroxide, titanium oxide, alumina, mica, zeolite, barium sulfate, aluminum hydroxide, boehmite, and the like. Note that in order to improve the water-absorbing property of the inorganic filler, an inorganic filler surface may be subjected to a hydrophilization treatment with, for example, a silane coupling agent.

The lower limit of the proportion at which the filler is contained in the porous layer may be not less than 0% by weight, may be more than 0% by weight, or may be not less than 10% by weight, when the total weight of the porous layer is regarded as 100% by weight. The filler is contained, in the porous layer, at the proportion of preferably not less than 20% by weight, more preferably not less than 30% by weight, and still more preferably not less than 50% by weight, from the viewpoint of an air permeability. The upper limit of the proportion at which the filler is contained in the porous layer is preferably not more than 80% by weight and more preferably not more than 70% by weight, when the total weight of the porous layer is regarded as 100% by weight.

The weight per unit area of the porous layer can be determined as appropriate in view of strength, thickness, weight, and handleability of the porous layer. The upper limit of the weight per unit area per layer of the porous layer is preferably not more than 3.5 g/m², more preferably not more than 3.0 g/m², and still more preferably not more than 2.5 g/m². The lower limit of the weight per unit area per layer of the porous layer is not particularly limited, but is preferably not less than 0.3 g/m², more preferably not less than 0.4 g/m², and still more preferably not less than 0.5 g/m². When the porous layer has a weight per unit area which is set to fall within these numerical ranges, the nonaqueous electrolyte secondary battery including the porous layer can have a higher weight energy density and a higher volume energy density.

The weight per unit area of the porous layer when formed on the laminated separator can be measured by comparing the weight of the laminated separator which has the polyolefin porous film and the porous layer with the weight of the laminated separator from which the porous layer is peeled off. The following is an example of such measurement.
1. The weight (W1) of the laminated separator having the polyolefin porous film and the porous layer is measured. Here, the areas of the laminated separator and the porous layer are each S1.
2. A peeling tape is attached to a surface of the laminated separator at which surface the porous layer is formed. By peeling off the peeling tape from the laminated separator, the porous layer is peeled off from the laminated separator to obtain the laminated separator from which the porous layer is peeled off. The laminated separator may have a “portion made which is constituted only by the polyolefin porous film” and a “portion in which the polyolefin porous film is permeated with a resin derived from the porous layer”.
3. The weight (W2) of the obtained laminated separator is measured.
4. The weight per unit area of the porous layer is calculated by a formula “(W1−W2)/S1”.

The porous layer has an air permeability of preferably 30 s/100 mL to 80 s/100 mL, and more preferably 40 s/100 mL to 75 s/100 mL, in terms of Gurley values. It can be said that the porous layer having an air permeability falling within these ranges has sufficient ion permeability.

The porous layer has a porosity of preferably 20% by volume to 90% by volume, and more preferably 30% by volume to 80% by volume, in order to achieve sufficient ion permeability. The porous layer has pores whose diameter is preferably not more than 1.0 μm, and more preferably not more than 0.5 μm. By setting each of the pores to have such a diameter, it is possible to obtain the porous layer having sufficient ion permeability.

The lower limit of the thickness per layer of the porous layer is preferably not less than 0.1 μm, more preferably not less than 0.3 μm, and still more preferably not less than 0.5 μm. The upper limit of the thickness of the porous layer is preferably not more than 20 μm, more preferably not more than 10 μm, and still more preferably not more than 5 μm. Examples of a combination of a lower limit and an upper limit of the thickness of the porous layer include 0.1 μm to 20 μm, 0.3 μm to 10 μm, and 0.5 μm to 5 μm. When the thickness of the porous layer falls within these ranges, it is possible for the porous layer to sufficiently exert a function of the porous layer (e.g., to impart heat resistance) and also to make the total thickness of the laminated separator reduced.

### Examples of Preferable Combination of Resin and Filler

In an embodiment, the resin contained in the porous layer has an intrinsic viscosity of 1.4 dL/g to 4.0 dL/g and the filler has an average particle diameter of not more than 1.0 μm. Use of the porous layer having such composition makes it possible to prepare a laminated separator which achieves all of heat resistance, ion permeability, and reduction in thickness.

The lower limit of the intrinsic viscosity of the resin contained in the porous layer is preferably not less than 1.4 dL/g and more preferably not less than 1.5 dL/g. The upper limit of the intrinsic viscosity of the resin contained in the porous layer is preferably not more than 4.0 dL/g, more preferably not more than 3.0 dL/g, and still more preferably not more than 2.0 dL/g. The porous layer containing the resin having an intrinsic viscosity of not less than 1.4 dL/g can impart sufficient heat resistance to the laminated separator. The porous layer containing the resin having an intrinsic viscosity of not more than 4.0 dL/g has sufficient ion permeability.

The intrinsic viscosity can be measured, for example, by the following method. Flow time is measured for each of (i) a solution obtained by dissolving the resin in a concentrated sulfuric acid (96% to 98%) and (ii) concentrated sulfuric acid (96% to 98%) in which no resin is dissolved. The intrinsic viscosity is determined from the measured flow time by the following formula.

$$Intrinsic viscosity [ dL / g ] = ln ( T / {T}_{0} ) / C$$

T: Flow time of concentrated sulfuric acid solution of resin
T₀: Flow time of concentrated sulfuric acid
C: Concentration of resin in concentrated sulfuric acid solution of resin [g/dL].

The resin having an intrinsic viscosity of 1.4 dL/g to 4.0 dL/g can be synthesized by adjusting a molecular weight distribution of the resin, the molecular weight distribution being adjusted by appropriately setting synthesis conditions (e.g., the amount of a monomer(s) to be put in, synthesis temperature, and synthesis time). Alternatively, a commercially available resin having an intrinsic viscosity of 1.4 dL/g to 4.0 dL/g may be used. In an embodiment, the resin having an intrinsic viscosity of 1.4 dL/g to 4.0 dL/g is an aramid resin.

The upper limit of the average particle diameter of the filler in the porous layer is preferably not more than 1.0 μm, and more preferably not more than 0.8 μm, from the viewpoint of reduction in thickness of the laminated separator. The lower limit of the average particle diameter of the filler in the porous layer is preferably not less than 0.005 μm, and more preferably not less than 0.010 μm, from the viewpoint of formation of a pore structure in the laminated separator.

The average particle diameter of the filler here is the average value of sphere equivalent particle diameters of 50 filler particles. A sphere equivalent particle diameter of a filler particle is a value which is obtained by actual measurement with use of a transmission electron microscope. The following is a specific example of a measurement method.
1. An image of the filler is captured with use of a transmission electron microscope (TEM; JEOL Ltd., transmission electron microscope JEM-2100F) at an acceleration voltage of 200 kV and a magnification ratio of 10,000 times with a Gatan Imaging Filter.
2. In the image thus obtained, an outline of a filler particle (primary particle) is traced with use of image analysis software (ImageJ), and the sphere equivalent particle diameter of the filler particle is measured.
3. The above measurement is carried out for 50 filler particles which have been randomly extracted. The arithmetic average of the sphere equivalent particle diameters of the 50 filler particles is regarded as the average particle diameter of the filler.

### <1.4. Particle Layer>

The laminated separator includes a particle layer which is provided on the at least one surface of the laminated separator. The particle layer may be provided on the surface of the laminated separator, or another layer may be further provided on the particle layer.

The particle layer may cover the entire surface of at least one surface of the porous layer, or it may partially cover the surface. The surface coverage on at least one surface of the porous layer with the particle layer may be not less than 1%, or may be not less than 5%. Further, the surface coverage may be not more than 100%, not more than 90%, not more than 70%, not more than 50%, or not more than 30%. As used herein, the surface coverage refers to the proportion of the area covered with the particle layer to the total area of one surface of the porous layer.

The lower limit of the weight per unit area of the particle layer on one surface of the laminated separator is preferably not less than 0.01 g/m², more preferably not less than 0.05 g/m², and still more preferably not less than 0.08 g/m². The upper limit of the weight per unit area of the particle layer on one surface of the laminated separator is preferably not more than 1.0 g/m², more preferably not more than 0.95 g/m², and still more preferably not more than 0.9 g/m². By setting the weight per unit area of the particle layer to fall within these ranges, it is possible to obtain the laminated separator having excellent ion permeability. The upper limit of the weight per unit area of the particle layer on one surface of the laminated separator may be less than 0.2 g/m², or may be not more than 0.15 g/m².

The weight per unit area of the particle layer is measured by comparing the weight of the laminated separator which has the particle layer with the weight of the laminated separator from which the particle layer is removed. The following is an example of such measurement.
1. The weight (W3) of the laminated separator which has the particle layer is measured. Further, the area (S2) of the particle layer is measured.
2. The particle layer is removed from the laminated separator by cleaning with an appropriate solvent. Thereafter, the solvent is removed, for example, by drying.
3. The weight (W4) of the laminated separator from which the particle layer has been removed is measured.
4. The weight per unit area of the particle layer is calculated by a formula “(W3−W4)/S2”.

The particle layer has an air permeability of preferably 0 s/100 mL to 150 s/100 mL, and more preferably 5 s/100 mL to 100 s/100 mL, in terms of Gurley values. It can be said that the particle layer having an air permeability falling within these ranges has sufficient ion permeability.

The particle layer has a porosity of preferably 1% by volume to 60% by volume, and more preferably 2% by volume to 30% by volume, so as to (i) retain an electrolyte in a larger amount and (ii) obtain the function of reliably preventing a flow of an excessively large electric current at a lower temperature.

The lower limit of the thickness of the particle layer on one surface of the laminated separator is preferably not less than 0.1 μm, more preferably not less than 0.3 μm, and still more preferably not less than 0.5 μm. The upper limit of the thickness of the particle layer on one surface of the laminated separator is preferably not more than 10 μm, more preferably not more than 8 μm, and still more preferably not more than 7 μm.

The lower limit of the average particle diameter of particles contained in the particle layer is preferably not less than 0.1 μm, more preferably not less than 0.3 μm, and still more preferably not less than 0.5 μm. The upper limit of the average particle diameter of the particles contained in the particle layer is preferably not more than 10.0 μm, more preferably not more than 8.0 μm, still more preferably not more than 7.0 μm, and particularly preferably less than 3.0 μm. When the average particle diameter is within these ranges, both the functionality of the particle layer (such as adhesiveness) and the reduction in thickness of the laminated separator can be achieved.

The average particle diameter of the particles is a value which is obtained by actual measurement with use of a scanning electron microscope. The following is a specific example of a measurement method.
1. A scanning electron microscope (SEM) image of a surface of the particle layer is captured with use of an SEM.
2. On the SEM image thus obtained, three or more fields of view are observed with use of image analysis software, respective outlines of not less than 100 particles are traced, and the particle diameter of each of the particles is measured.
3. The arithmetic average of the particles thus measured is regarded as the average particle diameter.

A resin which constitutes the particles may include a thermoplastic resin. Examples of a monomer that becomes a constituent unit of the resin which constitutes the particles include: vinyl chloride-based monomers such as vinyl chloride and vinylidene chloride; vinyl acetate-based monomers such as vinyl acetate; aromatic vinyl monomers such as styrene, α-methyl styrene, styrene sulfonic acid, butoxystyrene, and vinyl naphthalene; vinyl amine-based monomers such as vinyl amine; vinyl amide-based monomers such as N-vinyl formamide and N-vinyl acetamide; acid group-containing monomers such as monomers each having a carboxylic acid group, monomers each having a sulfonic acid group, monomers each having a phosphoric acid group, and monomers each having a hydroxyl group; (meth)acrylic acid derivatives such as 2-hydroxyethyl methacrylate; (meth)acrylic ester monomers such as methyl acrylate, ethyl acrylate, methyl methacrylate, ethyl methacrylate, and 2-ethylhexyl acrylate; (meth)acrylamide monomers such as acrylamide and methacrylamide; (meth)acrylonitrile monomers such as acrylonitrile and methacrylonitrile; fluorine-containing (meth)acrylate monomers such as 2-(perfluorohexyl)ethyl methacrylate and 2-(perfluorobutyl)ethyl acrylate; maleimides; maleimide derivatives such as phenylmaleimide; diene-based monomers such as 1,3-butadiene and isoprene; and vinylidene fluoride monomers. One of these monomers may be used alone, or two or more of these monomers may be used in combination at any ratio.

Among the above monomers, (meth)acrylic ester monomers and/or vinylidene fluoride monomers are preferable. That is, the particles preferably contain an acrylic resin that contains a (meth)acrylic ester monomer as a constituent unit and/or a polyvinylidene fluoride resin that contains a vinylidene fluoride monomer as a constituent unit.

In an embodiment, the particle layer contains acrylic resin. Examples of the acrylic resin include acrylic resins exemplified as the acrylic resins that can be included in the porous layer. Such a particle layer can readily exhibit the functionality of the particle layer (such as adhesiveness) sufficiently.

Examples of the polyvinylidene fluoride resin include polyvinylidene fluoride and copolymers of vinylidene fluoride and the other monomers. Examples of the other monomers copolymerizable with vinylidene fluoride include tetrafluoroethylene, hexafluoropropylene, trifluoroethylene, chlorotrifluoroethylene, trichloroethylene, vinyl fluoride, trifluoroperfluoropropyl ether, ethylene, (meth)acrylic acid, methyl (meth)acrylate, (meth)acrylic ester, vinyl acetate, vinyl chloride, and acrylonitrile.

Examples of a structure of the particles include a structure in which individual polymers having a particle shape exist separately, a structure in which individual polymers having a particle shape exist in contact with each other, and a structure in which individual polymers having a particle shape exist in a complexed form.

When the individual particles exist in contact with each other or in a complexed form, the particles may have, for example, a core-shell structure. The core-shell structure may have a shell that covers the entire outer surface of a core or a shell that partially covers the outer surface of the core. In view of ion permeability, the shell preferably partially covers the core. In the particles that have the core-shell structure in which the shell partially covers the core, it is preferable that there be two types of particles, that is, a core particle and shell particles, and that the shell particles cover the outer surface of the core particle. When the particles have the core-shell structure, the average particle diameter of the particles refers to the average of respective particle diameters of whole particles which have the core-shell structure.

Generally, thermocompression bonding of the electrode to the laminated separator is carried out at a temperature of not higher than 100° C. Therefore, the glass transition temperature of the particles is preferably not lower than 0° C. and not higher than 80° C. In view of prevention of adhesion of separators, the glass transition temperature is more preferably not lower than 20° C. and not higher than 80° C.

### <1.5. Physical Properties of Laminated Separator>

### (Air Permeability)

The laminated separator has an air permeability of preferably not more than 500 s/100 mL, more preferably not more than 400 s/100 mL, still more preferably not more than 350 s/100 mL, and particularly preferably not more than 300 s/100 mL, in terms of Gurley values. It can be said that the laminated separator having an air permeability falling within these ranges has sufficient ion permeability.

### (Porosity)

The laminated separator has a porosity of preferably 20% by volume to 80% by volume, more preferably 30% by volume to 70% by volume, and still more preferably 40% by volume to 60% by volume, so as to (i) retain an electrolyte in a larger amount and (ii) obtain the function of reliably preventing a flow of an excessively large electric current at a lower temperature.

### [2. Method for Producing Nonaqueous Electrolyte Secondary Battery Laminated Separator]

For example, the laminated separator can be produced by forming the porous layer using the porous film and then forming the particle layer.

### <2.1. Method for Producing Polyolefin Porous Film>

The following method is an example of a method for producing the porous film. That is, first, a polyolefin-based resin is kneaded together with a pore forming agent, such as an inorganic bulking agent or a plasticizer, and optionally with another agent(s), such as an antioxidant, so as to obtain a polyolefin-based resin composition. Then, the polyolefin-based resin composition is extruded, so that a polyolefin-based resin composition in a sheet form is prepared. Further, the pore forming agent is removed from the polyolefin-based resin composition in the sheet form with use of an appropriate solvent. Thereafter, the polyolefin-based resin composition from which the pore forming agent has been removed is stretched. In this manner, the porous film can be produced.

The inorganic bulking agent is not particularly limited. Examples of the inorganic bulking agent include inorganic fillers; one specific example is calcium carbonate. The plasticizer is not particularly limited. The plasticizer can be a low molecular weight hydrocarbon such as liquid paraffin.

### <2.2. Method for Producing Porous Layer>

The porous layer can be formed with use of a coating solution in which the resin described in the section <1.3. Porous layer> is dissolved or dispersed in a solvent. Further, the porous layer containing the resin and the filler can be formed with use of a coating solution which is obtained by (i) dissolving or dispersing the resin in a solvent and (ii) dispersing the filler in the solvent. The coating solution may contain, as appropriate, a disperser, a plasticizer, a surfactant, a pH adjustor, and/or the like, as a component(s) other than the resin and the filler.

Note that the solvent can be a solvent in which the resin is to be dissolved. Further, the solvent can be a dispersion medium in which the resin or the filler is to be dispersed. Examples of a method for forming the coating solution include a mechanical stirring method, an ultrasonic dispersion method, a high-pressure dispersion method, and a media dispersion method.

Examples of the method for forming the porous layer include: a method in which the coating solution is applied directly to a surface of a base material and then the solvent is removed; a method in which (i) the coating solution is applied to an appropriate support, (ii) the solvent is removed so that the porous layer is formed, (iii) the porous layer and the base material are bonded together by pressure, and then (iv) the support is peeled off; a method in which (i) the coating solution is applied to an appropriate support, (ii) the base material is bonded to an obtained coated surface by pressure, (iii) the support is peeled off, and then (iv) the solvent is removed; and a method in which dip coating is carried out by immersing the base material in the coating solution, and then the solvent is removed.

Here, the base material can be, for example, a film of another kind, the positive electrode, or the negative electrode, other than the above-described polyolefin porous film.

It is preferable that the solvent be a solvent which (i) does not adversely affect the base material, (ii) allows the resin to be dissolved uniformly and stably, and (iii) allows the filler to be dispersed uniformly and stably. The solvent can be one or more selected from the group consisting of, for example, N-methyl-2-pyrrolidone (NMP), N,N-dimethylacetamide, N,N-dimethylformamide, acetone, and water.

The coating solution can be applied to the base material by a conventionally known method. Specific examples of such a method include a gravure coater method, a dip coater method, a bar coater method, and a die coater method. The solvent can be removed from a film of the coating solution with which the base material has been coated, for example, by air blow drying or heat drying. When the coating solution contains an aramid resin, the aramid resin can be deposited by applying humidity to the coated surface. The porous layer can be formed in this way.

Further, the porosity and the average pore diameter of the porous layer to be obtained can be adjusted by changing the amount of the solvent in the coating solution. A suitable solid content concentration of the coating solution may vary depending on, for example, the type of the filler, but generally, the solid content concentration is preferably not less than 3% by weight and not more than 40% by weight.

When the base material is coated with the coating solution, a coating shear rate can vary depending on, for example, the type of the filler. Generally, the coating shear rate is preferably not lower than 2 (1/s) and more preferably 4 (1/s) to 50 (1/s).

It is preferable to impregnate the base material with a solvent before applying the coating solution to the base material. The solvent with which the base material is impregnated is preferably the same solvent as that contained in the coating solution, or is preferably an aqueous solution that contains the same solvent as that contained in the coating solution at a high concentration (not less than 70% by weight and less than 100% by weight). For example, when the solvent of the coating solution is NMP, the base material is preferably impregnated with NMP or an aqueous solution containing NMP at a high concentration before the coating solution is applied. A surface of the base material to which surface the coating solution is applied is different from a surface of the base material to which surface the solvent is impregnated into. In the present specification, such an impregnating method of the solvent is also referred to as “bottom-side impregnation”. The solvent for use in the bottom-side impregnation is preferably NMP or an aqueous solution containing 70% by weight to 99% by weight of NMP.

Further, the solvent contained in the coating solution is preferably replaced with a deposition solution containing a poor solvent having a low boiling point, such as water, alcohol, or acetone, so as to perform drying after deposition of the porous layer. In particular, by using the deposition solution containing the same solvent as that contained in the coating solution at a high concentration, the coefficient of variation of the compression amount during compression can be suitably controlled within the abovementioned ranges. The deposition solution can also be said to be a deposition solution obtained by diluting the poor solvent to a low concentration using the solvent exemplified as an example of the solvent contained in the coating solution. The deposition solution is preferably an aqueous solution containing NMP at a high concentration. The concentration of NMP in the deposition solution is preferably not less than 50% by weight and not more than 99% by weight, and may be not less than 70% by weight and not more than 99% by weight.

Alternatively, examples of the deposition method of the porous layer also include a method in which the porous layer is deposited by spraying a poor solvent and saturating air in a deposition tank with vapor of the poor solvent. In the present specification, such a deposition method of the porous layer with use of vapor of the poor solvent is also referred to as “humidity deposition”. In the humidity deposition, in particular, by spraying the poor solvent and air onto the surface to which the coating solution is applied using a two-fluid nozzle, the coefficient of variation of the compression amount during compression can be suitably controlled within the abovementioned ranges.

### (Method for Preparing Aramid Resin)

Examples of a method for preparing the aramid resin include, but are not particularly limited to, condensation polymerization of para-oriented aromatic diamine and para-oriented aromatic dicarboxylic acid halide. In such a method, the aramid resin obtained is substantially composed of repeating units in which amide bonds occur at para or quasi-para position in an aromatic ring. The “quasi-para positions” refers to positions at which bonds extend in opposing directions from each other, coaxially or in parallel, such as 4 and 4′ positions of biphenylene, 1 and 5 positions of naphthalene, and 2 and 6 positions of naphthalene.

### <2.3. Method for Producing Particle Layer>

The particle layer can be formed by applying, to the porous layer, a slurry that contains the abovementioned particles, and then drying the slurry. The slurry may contain another component in addition to the abovementioned particles. Examples of such another component include a binder, a disperser, and a wetting agent.

In forming the particle layer, a method for applying and drying the slurry is not particularly limited. Examples of the method for applying the slurry include a gravure coater method, a dip coater method, a bar coater method, and a die coater method.

Meanwhile, examples of the method for drying the slurry include drying by warm air, hot air, or low humidity air, vacuum drying, and drying by irradiation with (far) infrared rays or electron rays. The temperature at which the slurry applied is dried can be varied depending on the type of the solvent used.

### [3. Nonaqueous Electrolyte Secondary Battery Material and Nonaqueous Electrolyte Secondary Battery]

A nonaqueous electrolyte secondary battery material in accordance with an embodiment of the present invention includes a positive electrode, the abovementioned laminated separator, and a negative electrode, which are formed in this order. A nonaqueous electrolyte secondary battery in accordance with an embodiment of the present invention includes the abovementioned laminated separator.

The nonaqueous electrolyte secondary battery is not particularly limited in shape and can have any shape such as the shape of a thin plate (sheet), a disk, a cylinder, or a prism such as a cuboid. The nonaqueous electrolyte secondary battery is, for example, a nonaqueous electrolyte secondary battery that achieves an electromotive force through doping with and dedoping of lithium. The nonaqueous electrolyte secondary battery includes the material that is for a nonaqueous electrolyte secondary battery and that includes a positive electrode, the abovementioned laminated separator, and a negative electrode, which are formed in this order. Note that components, other than the abovementioned laminated separator, of the nonaqueous electrolyte secondary battery are not limited to those described below.

The nonaqueous electrolyte secondary battery is generally structured such that a battery element is enclosed in an exterior member, the battery element including (i) a structure in which the negative electrode and the positive electrode face each other with the abovementioned laminated separator therebetween and (ii) an electrolyte with which the structure is impregnated. Note that the doping means occlusion, support, adsorption, or insertion, and means a phenomenon in which lithium ions enter an active material of an electrode (e.g., a positive electrode).

### <3.1. Positive Electrode>

The positive electrode is not limited to any particular one, provided that the positive electrode is one that is generally used as a positive electrode of a nonaqueous electrolyte secondary battery. Examples of the positive electrode include a positive electrode sheet having a structure in which an active material layer, containing a positive electrode active material and a binding agent, is formed on a positive electrode current collector. Note that the active material layer may further contain an electrically conductive agent and/or a binding agent.

Examples of the positive electrode active material include materials each capable of being doped with and dedoped of lithium ions. Specific examples of the materials include lithium complex oxides each containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and fired products of organic polymer compounds. Only one of these electrically conductive agents may be used, or two or more of these electrically conductive agents may be used in combination.

Examples of the binding agent include: fluorine-based resins such as polyvinylidene fluoride (PVdF); acrylic resin; and styrene butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet includes: a method in which the positive electrode active material, the electrically conductive agent, and the binding agent are pressure-molded on the positive electrode current collector; and a method in which (i) the positive electrode active material, the electrically conductive agent, and the binding agent are formed into a paste with use of an appropriate organic solvent, (ii) the positive electrode current collector is coated with the paste, and (iii) the paste is dried and then pressurized so that the paste is firmly fixed to the positive electrode current collector.

### <3.2. Negative Electrode>

The negative electrode is not limited to any particular one, provided that the negative electrode is one that is generally used as a negative electrode of a nonaqueous electrolyte secondary battery. Examples of the negative electrode include a negative electrode sheet having a structure in which an active material layer, containing a negative electrode active material and a binding agent, is formed on a negative electrode current collector. Note that the active material layer may further contain an electrically conductive agent and/or a binding agent.

Examples of the negative electrode active material include materials each capable of being doped with and dedoped of lithium ions. Examples of the materials include carbonaceous materials. Examples of the carbonaceous materials include natural graphite, artificial graphite, cokes, carbon black, and pyrolytic carbons.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressurized so that the paste is firmly fixed to the negative electrode current collector. The paste preferably contains the electrically conductive agent and the binding agent.

### <3.3. Nonaqueous Electrolyte>

A nonaqueous electrolyte is not limited to any particular one, provided that the nonaqueous electrolyte is one that is generally used for a nonaqueous electrolyte secondary battery such as a lithium ion secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salts, and LiAlCl₄. Only one of these lithium salts may be used, or two or more of these lithium salts may be used in combination.

Examples of the organic solvent to be contained in the nonaqueous electrolyte include carbonates, ethers, esters, nitriles, amides, carbamates, sulfur-containing compounds, and fluorine-containing organic solvents each obtained by introducing a fluorine group into any of these organic solvents. Only one of the above organic solvents may be used, or two or more of the above organic solvents may be used in combination.

### <3.4. Method for Producing Nonaqueous Electrolyte Secondary Battery>

The nonaqueous electrolyte secondary battery can be produced by a conventionally known method. For example, first, the nonaqueous electrolyte secondary battery material is formed by disposing the positive electrode, the abovementioned laminated separator, and the negative electrode in this order. Next, the nonaqueous electrolyte secondary battery material is put into a container which serves as a housing for the nonaqueous electrolyte secondary battery. Further, the container is filled with the nonaqueous electrolyte, and then hermetically sealed while pressure is reduced in the container. In this way, the nonaqueous electrolyte secondary battery can be produced.

The present invention is not limited to the embodiments, but can be altered by a skilled person in the art within the scope of the claims. The present invention also encompasses, in its technical scope, any embodiment derived by combining technical means disclosed in differing embodiments.

4. Aspects of the present invention can also be expressed as follows:

Embodiments of the present invention may include the following configurations.

<1>

A laminated separator that is for a nonaqueous electrolyte secondary battery, including a polyolefin porous film, and a porous layer provided on one surface or both surfaces of the polyolefin porous film,
the laminated separator further including a particle layer on at least one surface,
the laminated separator satisfying the following formula,
the laminated separator:

$$( coefficient of variation of compression amount during compression at 5 MPa ) \div ( coefficient of variation of compression amount during compression at 1 MPa ) \leq 0.9 . \qquad < 2 >$$

The laminated separator of <1>, wherein the porous layer contains at least one resin selected from the group consisting of acrylic resin, aromatic polyamide, polyimide, polyamide imide, and polyvinylidene fluoride.

<3>

The laminated separator of <1> or <2>, wherein the particle layer contains acrylic resin.

<4>

The laminated separator of any one of <1> to <3>, wherein an average particle diameter of particles contained in the particle layer is not less than 0.1 μm and less than 3.0 μm.

<5>

A nonaqueous electrolyte secondary battery material including a positive electrode, a laminated separator for a nonaqueous electrolyte secondary battery recited in any one of <1> to <4>, and a negative electrode, which are formed in this order.

<6>

A nonaqueous electrolyte secondary battery including a laminated separator for a nonaqueous electrolyte secondary battery recited in any one of <1> to <4>.

### EXAMPLES

The following description will discuss examples of the present invention.

### [Testing Method]

### [Coefficient of Variation of Compression Amount]

The measurement and the calculation were carried out according to the following procedure.
1. A piece of the laminated separator which was cut out to have dimensions of 1.5 cm square was brought into close contact with a sample stage as a sample.
2. A microcompression testing machine (MCT-510, SHIMADZU CORPORATION) was used to press, into a surface of the sample, a diamond flat indenter having a diameter of 50 μm. The indenter was pressed at a speed of 0.45 mN/s until the indentation pressure reached 20 mN (10.2 MPa).
3. A curve obtained by plotting the position of the indenter on the horizontal axis and the indentation pressure on the vertical axis was analyzed, and the compression amount at an indentation pressure of 1 MPa or 5 MPa was determined using the following formula. The position of the indenter at the start of contact between the indenter and the sample refers to the position of the indenter at the time point where the indentation pressure begins to increase.

$$( Compression amount at indentation pressure of 1 MPa or 5 MPa ) = ( position of indenter when the indentation pressure is 1 MPa or 5 MPa ) - ( position of the indenter at the start of contact between the indenter and the sample )$$

4. For each sample, the compression amount was determined at a total of 15 locations while changing the measurement points. From these data, average values and standard deviations were determined. The value obtained by dividing the standard deviation by the average value was defined as the coefficient of variation.

### [Stability of High-Rate Performance]

### <Preparation of Nonaqueous Electrolyte Secondary Battery for Test>

A nonaqueous electrolyte secondary battery for a test was prepared according to the following procedure.
1. A positive electrode and a negative electrode were prepared. As the positive electrode, an electrode hoop (JFE Techno-Research Corporation) having a thickness of 51 μm and a density of 2.95 g/cm³ was used. The composition of a positive electrode active material was such that the amount of LiNi_{0.8}Co_{0.15}Al_{0.05}O₂ was 92 parts by weight, the amount of an electrically conductive agent was 4 parts by weight, and the amount of a binding agent was 4 parts by weight. As the negative electrode, an electrode hoop (JFE Techno-Research Corporation) having a thickness of 59 μm and a density of 1.45 g/cm³ was used. The composition of a negative electrode active material was such that the amount of artificial graphite was 96.5 parts by weight, the amount of a binding agent was 2 parts by weight, and the amount of carboxymethyl cellulose was 1.5 parts by weight.
2. The positive electrode, the laminated separator, and the negative electrode were formed in this order in a laminate pouch, to prepare a nonaqueous electrolyte secondary battery material. At this time, the laminated separator was placed in the direction where the positive electrode active material layer and the particle layer come into contact.
3. The nonaqueous electrolyte secondary battery material was stored in a bag which was made up of an aluminum layer and a heat-sealing layer formed on top of each other, and was pressed using a press machine. Pressing was carried out at 85° C. at 1 MPa for 40 seconds.
4. A volume of 230 μL of nonaqueous electrolyte was injected into the bag. This nonaqueous electrolyte was prepared by dissolving vinylene carbonate and LiPF₆ in a mixed solvent. The mixed solvent was made up by mixing ethylene carbonate, ethyl methyl carbonate, and diethyl carbonate at a ratio of 3:5:2 (volume ratio). The vinylene carbonate had a concentration of 1% by weight. LiPF₆ had a concentration of 1 mol/L.
5. The bag was heat-sealed while pressure inside the bag was reduced. In this way, the nonaqueous electrolyte secondary battery for a test was prepared.

### <Measurement of Rate Discharge Capacity Retention Rate>

The measurement was carried out according to the following procedure.
1. The nonaqueous electrolyte secondary battery for a test was subjected to initial charging. Initial charging was carried out under a condition that the voltage range was 2.7 V to 4.2 V, the current values were 0.1C (charge) and 0.2C (discharge), the number of cycles was one cycle, and the temperature was 25° C. Here, 1C is a current value at which a battery rated capacity derived from a one-hour rate discharge capacity is discharged in one hour (the same applied hereinafter).
2. The nonaqueous electrolyte secondary battery was aged. Aging was carried out under a condition that the current values were 1C (charge) and 5C (discharge), and the number of cycles was 10 cycles.
3. The nonaqueous electrolyte secondary battery was subjected to charge and discharge cycles. Charge and discharge cycles were carried out under a condition that the charging current value was 1.0C, the cutoff voltage was 2.7V, the discharge current value was varied sequentially from the first cycle as 0.2C, 1C, 2C, 3C, 4C, 5C, 6C, 7C, and 0.2C, the total number of cycles was nine cycles, and the temperature was 25° C. The discharge capacity (mAh) was measured at each discharge.
4. The rate discharge capacity retention rate was calculated based on the following formula.

$$Rate discharge capacity retention rate ( \% ) = \{ discharge capacity ( mAh ) at 6 th discharge ( 5 C ) \div discharge capacity ( mAh ) at 1 st discharge ( 0.2 C ) \} \times 100$$

5. Using another laminated separator prepared in the same Example or Comparative Example, the rate discharge capacity retention rate was measured in triplicate. From those measurement values, the average and standard deviation of the rate discharge capacity retention rate were calculated.

### SYNTHESIS EXAMPLES

### Synthesis Example 1

Resin A (poly(4,4′-diphenylsulfonyl terephthalamide)) was synthesized by the following procedure.
1. A 0.5-L separable flask having a stirring blade, a thermometer, a nitrogen incurrent canal, and a powder addition port was sufficiently dried.
2. Into the flask, 408.6 g of NMP was introduced. Further, 31.4 g of calcium chloride (having been dried at 200° C. for 2 hours) was added, and a resulting mixture was heated to 100° C.
3. After the calcium chloride completely dissolved, 31.97 g of 4,4′-diaminodiphenylsulfone (DDS) was added at 100° C., and then a resulting mixture was completely dissolved.
4. A resulting solution was cooled to room temperature. While the temperature of the solution was maintained at 25±2° C., 25.88 g in total of terephthalic acid dichloride (TPC) was added in 3 separate portions.
5. While the temperature of a resulting solution was maintained at 25±2° C., the solution was matured for 1 hour to obtain the solution that contained the resin A.

### Synthesis Example 2

Resin B (poly(paraphenylene terephthalamide)) was synthesized by the following procedure.
1. A 0.5-L separable flask having a stirring blade, a thermometer, a nitrogen incurrent canal, and a powder addition port was sufficiently dried.
2. Into the flask, 408.6 g of NMP was introduced. Further, 31.4 g of calcium chloride (having been dried at 200° C. for 2 hours) was added, and a resulting mixture was heated to 100° C.
3. After the calcium chloride completely dissolved, the temperature of the solution was returned to room temperature. Subsequently, 13.20 g of paraphenylenediamine (PPD) was added and completely dissolved.
4. While the temperature of a resulting solution was maintained at 25±2° C., 24.24 g in total of TPC was added in 3 separate portions.
5. While the temperature of a resulting solution was maintained at 25±2° C., the solution was matured for 1 hour to obtain the solution that contained the resin B.

### Synthesis Example 3

Resin C (block copolymer having a block of poly(4,4′-diphenylsulfonyl terephthalamide)) was synthesized by the following procedure.
1. A separable flask with a capacity of 5 L having a stirring blade, a thermometer, a nitrogen incurrent canal, and a powder addition port was sufficiently dried.
2. Into the flask, 4235 g of NMP was introduced. Further, 325.6 g of calcium chloride was added to the flask, and a resulting mixture was heated to 100° C. In this way, calcium chloride was completely dissolved to obtain a calcium chloride solution (7.14% by weight). Water was added to the calcium chloride solution, calculated to achieve a water content of 450 ppm. Here, calcium chloride having been subjected to vacuum drying at 200° C. for 2 hours in advance was used.
3. While the temperature of a resulting solution was maintained at 40° C., 94.06 g of DDS was added and completely dissolved.
4. The temperature of a resulting solution was lowered to 25° C. While the temperature of the solution was maintained at 25±2° C., 77.38 g in total of TPC was added in 3 separate portions. By reacting for 1 hour, block A1 constituted by poly(4,4′-diphenylsulfonyl terephthalamide) was synthesized. At this point, the molar ratio of DDS to TPC was 0.994.
5. An amount of 95.61 g of PPD was added to the flask and completely dissolved over 1 hour.
6. While the temperature of a resulting solution was maintained at 25±2° C., 175.95 g in total of TPC was added in 3 separate portions. By reacting for 1.5 hours, block B1 constituted by poly(paraphenylene terephthalamide) was caused to extend from both sides of the block A1. At this point, the molar ratio of PPD to TPC was 1.020.
7. While the temperature of the solution was maintained at 20±2° C., the solution was matured for 1 hour. In this way, a solution containing the resin C was obtained. The block copolymer contained in the solution containing the resin C was composed of 30% of the block A1 and 70% of the block B1 in terms of the entire molecule. The solution containing the resin C contained an aramid resin containing the block copolymer.
8. Alumina (average particle diameter: 13 nm) was added to the solution containing the resin C and mixed. At this time, alumina was added so that the weight ratio between the aramid resin containing the block copolymer and alumina was 1:1.
9. To the mixed solution obtained in Step 8, NMP as a diluent and calcium carbonate as a neutralizer were added, making the solid content 4% by weight. Herein, the “solid content” refers to the proportion of the aramid resin and alumina. This solution was stirred for 20 minutes to dilute and neutralize it. This neutralized solution was defoamed under reduced pressure to prepare a coating solution (2) in slurry form.

### Synthesis Example 4

Resin D (block copolymer having a block of poly(4,4′-diphenylsulfonyl terephthalamide)) was synthesized by the following procedure.
1. A separable flask with a capacity of 5 L having a stirring blade, a thermometer, a nitrogen incurrent canal, and a powder addition port was sufficiently dried.
2. Into the flask, 4129 g of NMP was introduced. Further, 359.1 g of calcium chloride was added to the flask, and a resulting mixture was heated to 100° C. In this way, calcium chloride was completely dissolved to obtain a calcium chloride solution (8.0% by weight). Water was added to the calcium chloride solution, calculated to achieve a water content of 432 ppm. Here, calcium chloride having been subjected to vacuum drying at 200° C. for 2 hours in advance was used.
3. While the temperature of a resulting solution was maintained at 40° C., 1393 g of DDS was added and completely dissolved. 4. The temperature of a resulting solution was lowered to 25° C. While the temperature of the solution was maintained at 25±2° C., 1136 g in total of TPC was added in 3 separate portions. By reacting for 1 hour, block A2 constituted by poly(4,4′-diphenylsulfonyl terephthalamide) was synthesized. At this point, the molar ratio of DDS to TPC was 1.003.
5. An amount of 606.9 g of PPD was added to the flask and completely dissolved over 1 hour.
6. While the temperature of a resulting solution was maintained at 25±2° C., 1109 g in total of TPC was added in 3 separate portions. By reacting for 1.5 hours, block B2 constituted by poly(paraphenylene terephthalamide) was caused to extend from both sides of the block A2. At this point, the molar ratio of PPD to TPC was 1.027.
7. While the temperature of the solution was maintained at 20±2° C., the solution was matured for 1 hour. In this way, a solution containing the resin D was obtained. The block copolymer contained in the solution containing the resin D was composed of 50% of the block A2 and 50% of the block B2 in terms of the entire molecule. The solution containing the resin D contained an aramid resin containing the block copolymer.
8. Alumina (average particle diameter: 13 nm) was added to the solution containing the resin D and mixed. At this time, alumina was added so that the weight ratio between the aramid resin containing the block copolymer and alumina was 1:1.
9. To the mixed solution obtained in Step 8, NMP as a diluent and calcium carbonate as a neutralizer were added, making the solid content 4% by weight. Herein, the “solid content” refers to the proportion of the aramid resin and alumina. This solution was stirred for 20 minutes to dilute and neutralize it. This neutralized solution was defoamed under reduced pressure to prepare a coating solution (3) in slurry form.

### EXAMPLES AND COMPARATIVE EXAMPLES

### Example 1

A porous layer that contained the resin A and the resin B at a weight ratio of 40:60 was prepared. Specifically, the solutions obtained in Synthesis Examples 1 and 2 were mixed so that the weight ratio between the resin A and the resin B was 40:60. To 500 g of the mixture (1) thus obtained, 11.68 g of calcium carbonate was added. A resulting solution was stirred for 10 minutes so as to be neutralized to obtain a neutralized solution (1). Then, the neutralized solution (1) was diluted with NMP and defoamed under reduced pressure to prepare a coating solution (1) in slurry form. The coating solution (1) had a solid content concentration of 3% by weight.

Next, a laminated separator (1) having a particle layer on the porous layer was prepared by the following procedure.
1. A polyethylene porous film (thickness: 11 μm) was unwounded from a roll.
2. An impregnation roll was used to impregnate one surface of the polyethylene porous film with NMP.
3. A bar coater was used to apply the coating solution (1) to the polyethylene porous film. At this time, the amount of the coating solution (1) applied was adjusted so that the porous layer had a weight per unit area of 1.7 g/m². A surface to which the coating solution (1) was applied was different from the surface which was impregnated with NMP in step 2.
4. The polyethylene porous film to which the coating solution (1) was applied was introduced into an immersion tank. The polyethylene porous film to which the coating solution (1) was applied was immersed into the immersion tank filled with a mixed solution of ion exchanged water and NMP at 50:50 (weight ratio), to deposit the porous layer.
5. The polyethylene porous film on which the porous layer was deposited was rinsed with water and then subjected to hot air drying to remove moisture, to obtain a heat-resistant separator (1).
6. Organic compound particles (PX-SA01, manufactured by Zeon Corporation) made of a styrene-acrylic cross-linked polymer compound having an average particle diameter of 0.65 μm and ultrapure water as a solvent were mixed at a weight ratio of 3:97, so that a slurry was obtained.
7. The slurry was applied onto a surface which was of the heat-resistant separator (1) and on which the porous layer was formed so that the surface coverage on one surface of the particle layer could be 20%. After the application, the slurry was dried at 50° C. in a dryer to obtain a laminated separator (1).

### Example 2

A laminated separator (2) was obtained by carrying out an operation similar to that in Example 1, except that the surface coverage on one surface of the particle layer was changed to 5%.

### Example 3

A laminated separator (3) was obtained by carrying out an operation similar to that in Example 1, except that the porous layer was deposited by spraying water and air via a two-fluid nozzle onto the coated surface at a flow rate of 100 mL/min at room temperature instead of introducing the polyethylene porous film to which the coating solution (1) was applied in step 4 into the immersion tank.

### Example 4

A laminated separator (4) was obtained by carrying out an operation similar to that in Example 1, except that the film thickness of the polyethylene porous film in step 1 was changed to 9 μm and the mixed solution of the immersion tank in step 4 was changed to a mixed solution of ion exchanged water and NMP at 30:70 (weight ratio).

### Example 5

A laminated separator (5) having a particle layer on the porous layer was prepared by the following procedure.
1. A polyethylene porous film (thickness: 10 μm) was unwounded from a roll.
2. An impregnation roll was used to impregnate one surface of the polyethylene porous film with NMP.
3. A bar coater was used to apply the coating solution (2) to the polyethylene porous film. At this time, the amount of the coating solution (2) applied was adjusted so that the porous layer had a weight per unit area of 0.6 g/m². A surface to which the coating solution (2) was applied was different from the surface which was impregnated with NMP in step 2.
4. The polyethylene porous film to which the coating solution (2) was applied was introduced into a deposition tank set at 50° C. and 70% relative humidity, to expose the film to air containing water vapor at 50° C. and 70% relative humidity. By doing this, a porous layer was deposited on one surface (first surface) of the polyethylene porous film.
5. The coating solution (2) was applied to the other surface (second surface) of the polyethylene porous film. At this time, the amount of the coating solution (2) applied was adjusted so that the porous layer had a weight per unit area of 1 g/m².
6. The polyethylene porous film to which the coating solution (2) was applied was introduced into an immersion tank. The polyethylene porous film to which the coating solution (2) was applied was immersed into the immersion tank filled with a mixed solution of ion exchanged water and NMP at 30:70 (weight ratio), to also deposit the porous layer on the other surface (second surface) of the polyethylene porous film.
7. The polyethylene porous film, on which the porous layers were deposited on both surfaces, was rinsed with water and then subjected to hot air drying to remove moisture, to obtain a heat-resistant separator (6).
8. Organic compound particles (PX-SA01, manufactured by Zeon Corporation) made of a styrene-acrylic cross-linked polymer compound having an average particle diameter of 0.65 μm and ultrapure water as a solvent were mixed at a weight ratio of 3:97, so that a slurry was obtained.
9. The slurry was applied onto a surface of the porous layer formed on the other surface (second surface) of the polyethylene porous film so that the surface coverage on one surface of the particle layer could be 20%. After the application, the slurry was dried at 50° C. in a dryer to obtain a laminated separator (5) having the particle layer on one surface.

### Example 6

A laminated separator (6) was obtained by carrying out an operation similar to that in Example 6, except that the coating solution (3) was used.

### Comparative Example 1

A laminated separator (7) was obtained by carrying out an operation similar to that in Example 2, except that the mixed solution of the immersion tank in step 4 was changed to ion exchanged water.

### Comparative Example 2

A laminated separator (8) was obtained by carrying out an operation similar to that in Example 1, except that the mixed solution of the immersion tank in step 4 was changed to ion exchanged water.

### [Evaluation Results]

The evaluation results are listed in Table 1. In Table 1, the 5C rate characteristic refers to the abovementioned rate discharge capacity retention rate.

TABLE 1

| | | | Particle layer | |
|---|---|---|---|---|
| | Porous layer | | | Surface |
| | | Deposition | | coverage |
| | Composition | conditions | Composition | (%) |
| Ex. 1 | Resin A + | Immersion | Styrene-acrylic | 20 |
| | Resin B | (NMP: 50%) | | |
| Ex. 2 | Resin A + | Immersion | Styrene-acrylic | 5 |
| | Resin B | (NMP: 50%) | | |
| Ex. 3 | Resin A + | Humidity | Styrene-acrylic | 20 |
| | Resin B | (two-fluid | | |
| | | nozzle) | | |
| Ex. 4 | Resin A + | Immersion | Styrene-acrylic | 20 |
| | Resin B | (NMP: 70%) | | |
| Ex. 5 | Resin C + | Immersion | Styrene-acrylic | 20 |
| | Alumina | (NMP: 70%) | | |
| Ex. 6 | Resin D + | Immersion | Styrene-acrylic | 20 |
| | Alumina | (NMP: 70%) | | |
| Comp. | Resin A + | Immersion | Styrene-acrylic | 5 |
| Ex. 1 | Resin B | (water: 100%) | | |
| Comp. | Resin A + | Immersion | Styrene-acrylic | 20 |
| Ex. 2 | Resin B | (water: 100%) | | |

| | Coefficients of | | | Ratio of | | Rate discharge | |
|---|---|---|---|---|---|---|---|
| | variation of | | | coefficient | | capacity retention | |
| | compression amount | | | of variation | | rate (%) | |
| | 1 MPa | 5 MPa | 10 MPa | 5 MPa/1 MPa | 10 MPa/1 MPa | Average | S.D. |
| Ex. 1 | 0.25 | 0.16 | 0.10 | 0.658 | 0.409 | 38 | 0.17 |
| Ex. 2 | 0.28 | 0.17 | 0.11 | 0.593 | 0.409 | 42 | 0.69 |
| Ex. 3 | 0.37 | 0.26 | 0.18 | 0.703 | 0.491 | 39 | 0.13 |
| Ex. 4 | 0.43 | 0.23 | 0.13 | 0.533 | 0.295 | 42 | 0.91 |
| Ex. 5 | 0.35 | 0.18 | 0.13 | 0.514 | 0.363 | 41 | 1.06 |
| Ex. 6 | 0.56 | 0.18 | 0.11 | 0.321 | 0.187 | 44 | 0.72 |
| Comp. | 0.18 | 0.20 | 0.16 | 1.126 | 0.884 | 35 | 1.54 |
| Ex. 1 | | | | | | | |
| Comp. | 0.20 | 0.19 | 0.16 | 0.945 | 0.822 | 34 | 2.09 |
| Ex. 2 | | | | | | | |

As shown in Table 1, the values obtained by dividing the coefficient of variation of the compression amount during compression at 5 MPa by the coefficient of variation of the compression amount during compression at 1 MPa were not more than 0.9 in the laminated separators in accordance with Examples and more than 0.9 in the laminated separators in accordance with Comparative Examples. The average rate discharge capacity retention rates were approximately the same between the laminated separators in accordance with Examples and the laminated separators in accordance with Comparative Examples. Further, the laminated separators in accordance with Examples had lower standard deviations of the rate discharge capacity retention rates. From this, it can be said that the laminated separators in accordance with Examples exhibit smaller variation in high-rate performance when pressurized and have higher stability.

As can also be seen from Table 1, to control the value obtained by dividing the coefficient of variation of the compression amount during compression at 5 MPa by the coefficient of variation of the compression amount during compression at 1 MPa, it may be sufficient, for example, to adjust the deposition conditions of the porous layer. Specifically, it is possible to produce a laminated separator having a ratio of coefficients of variation of not more than 0.9 by carrying out immersion into the mixed solution containing not less than 50% by weight of NMP to deposit the porous layer or by carrying out humidity deposition of a porous layer using a two-fluid nozzle.

### INDUSTRIAL APPLICABILITY

An aspect of the present invention is applicable to a nonaqueous electrolyte secondary battery.

### REFERENCE SIGNS LIST

1 Polyolefin porous film
2, 2a, 2b Porous layer
3, 3a, 3b Particle layer
4a, 4b, 4c, 4d Laminated separator
5, 5a, 5b Laminate

1. A laminated separator that is for a nonaqueous electrolyte secondary battery, comprising a polyolefin porous film, and a porous layer provided on one surface or both surfaces of the polyolefin porous film,
the laminated separator further comprising a particle layer on at least one surface,
the laminated separator satisfying the following formula,
the laminated separator:
$$( coefficient of variation of compression amount during compression at 5 MPa ) \div ( coefficient of variation of compression amount during compression at 1 MPa ) \leq 0.9 .$$

2. The laminated separator of claim 1, wherein the porous layer contains at least one resin selected from the group consisting of acrylic resin, aromatic polyamide, polyimide, polyamide imide, and polyvinylidene fluoride.

3. The laminated separator of claim 1, wherein the particle layer contains acrylic resin.

4. The laminated separator of claim 1, wherein an average particle diameter of particles contained in the particle layer is not less than 0.1 μm and less than 3.0 μm.

5. A material for a nonaqueous electrolyte secondary battery, comprising a positive electrode, a laminated separator for a nonaqueous electrolyte secondary battery recited in claim 1, and a negative electrode, which are formed in this order.

6. A nonaqueous electrolyte secondary battery comprising a laminated separator for a nonaqueous electrolyte secondary battery recited in claim 1.
